(19) United States
(12) Patent Application Publication
(10) Pub. No.: US 2025/0253365 A1
(43) Pub. Date: Aug. 7, 2025

(54) PRESSURIZED DUCT FOR A FUEL CELL

(71) Applicant: GM Global Technology Operations LLC, Detroit, MI (US)

(72) Inventors: Seongchan Pack, West Bloomfield Township, MI (US); Sean Michael Commet, Holly, MI (US); Bikal Adhikari, Troy, MI (US); William B. Carroll, Leonard, MI (US)

(73) Assignee: GM Global Technology Operations LLC, Detroit, MI (US)

(21) Appl. No.: 18/434,945

(22) Filed: Feb. 7, 2024

(51) Int. Cl. H01M 8/04082; F16L 57/04

(52) U.S. Cl. CPC H01M 8/04216; F16L 57/04; H01M 2250/20

(57) ABSTRACT

A duct for a fuel cell includes a duct body defining an aperture configured to allow fluid to flow therethrough. The duct body includes a flexible network configured to provide adjustable flexibility to the duct body. Additionally, a surface coating is disposed on an outer surface of the duct body. Moreover, the surface coating provides the duct body with one or more of flame retardance and structural integrity.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to pressurized ducts for fuel cells.

Fuel cells are a clean energy source such that, when fueled with pure hydrogen, the only by-products are heat and water, making fuel cells a sustainable power source.

While fuel cells are a source of clean energy, the inside of a fuel cell includes high hydrogen concentrations, saturated water, and high humidity. As such, components within a fuel cell must be able to withstand these harsh environmental conditions. For example, fuel cells typically include a plurality of ducts that carry fluid between anode and cathode components. Such ducts, typically formed from plastic via an injection molding process or a blow molding process, must be highly flame retardant. While forming ducts for fuel cells that are flame retardant is possible, materials and processes used in forming such ducts often results in a loss of flexibility. Accordingly, forming a duct with sufficient flexibility that is concurrently flame retardant is desirable.

### SUMMARY

In one configuration, a duct for a fuel cell includes a duct body defining an aperture configured to allow fluid to flow therethrough. The duct body includes a flexible network configured to provide adjustable flexibility to the duct body. Additionally, the pressurized duct includes a surface coating disposed on an outer surface of the duct body. Moreover, the surface coating provides the duct body with one or more of flame retardance or structural integrity.

The duct may also include one or more of the following optional features. For example, the duct body may be comprised of one or more of polyamide, polyphthalamide, polybutylene terephthalate, polyketone, polyether ether ketone, polyetherketoneketone, polyimide, polyamide imide, or poly (ether-ester) elastomer. Additionally, the duct body may be reinforced using one or more of glass fiber, carbon fiber, or graphene. Moreover, the flexible network may be comprised of stackable fabric. Additionally, the flexible network may include an adhesive containing soft segments and hard segments. Moreover, the duct body and surface coating may be produced using spraying, curing, or molding. Additionally, the surface coating may be a continuous coating over the outer surface of the duct body. Moreover, the duct body may plasticize or harden when exposed to hydrogen gas (H₂). Additionally, the surface coating may be comprised of cross-linked polymers. Moreover, a fuel cell may incorporate the pressurized duct. Further, a vehicle may incorporate the fuel cell.

In another configuration, a fuel cell system includes an anode, a cathode, an anode duct configured to provide fluid transmission to the anode, and a cathode duct configured to provide fluid transmission to the cathode. Additionally, one of the anode duct or the cathode duct is a flexible duct including a duct body comprised of a flexible network and configured to provide adjustable flexibility to the duct body. Additionally, the flexible duct includes a surface coating disposed on an outer surface of the duct body, the surface coating being comprised of cross-linked polymers or flame retardant materials.

The fuel cell system may also include one or more of the following optional features. For example, the cross-linked polymers may include epoxy, acrylic base, and polyurethane. Additionally, the flame retardant materials may include aryl phosphate, aluminum phosphate, aluminum-zinc phosphate, nitrogen-phosphorous derivatives, aluminum oxide, zinc oxide, iron oxide, or graphene oxide. Moreover, the surface coating may be a continuous coating over the outer surface of the duct body. Additionally, the duct body may plasticize or harden when exposed to hydrogen gas (H₂). Moreover, a vehicle may incorporate the fuel cell.

In yet another configuration, a duct for a fuel cell includes a duct body defining an aperture configured to allow fluid to flow therethrough. Additionally, the duct body includes a flexible network comprised of one or more of a polymeric material or an inorganic material. The pressurized duct also includes a surface coating disposed on an outer surface of the duct body. Moreover, the surface coating is comprised of one or more of epoxy, acrylic base, polyurethane, aryl phosphate, aluminum phosphate, aluminum-zinc phosphate, nitrogen-phosphorous derivatives, aluminum oxide, zinc oxide, iron oxide, or graphene oxide and is configured to provide increased structural properties or enhanced flame retardance properties to the duct body.

The duct may also be incorporated into a fuel cell. Moreover, the fuel cell may be incorporated into a vehicle.

### BRIEF DESCRIPTION OF THE DRAWINGS

The drawings described herein are for illustrative purposes only of selected configurations and are not intended to limit the scope of the present disclosure.

FIG. 1 is an exterior perspective view of a vehicle including a fuel cell;

FIG. 2 is a partial cross-sectional view of a duct of the fuel cell according to the present disclosure; and

FIG. 3 is an end view of the duct of the fuel cell according to the present disclosure.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICS (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

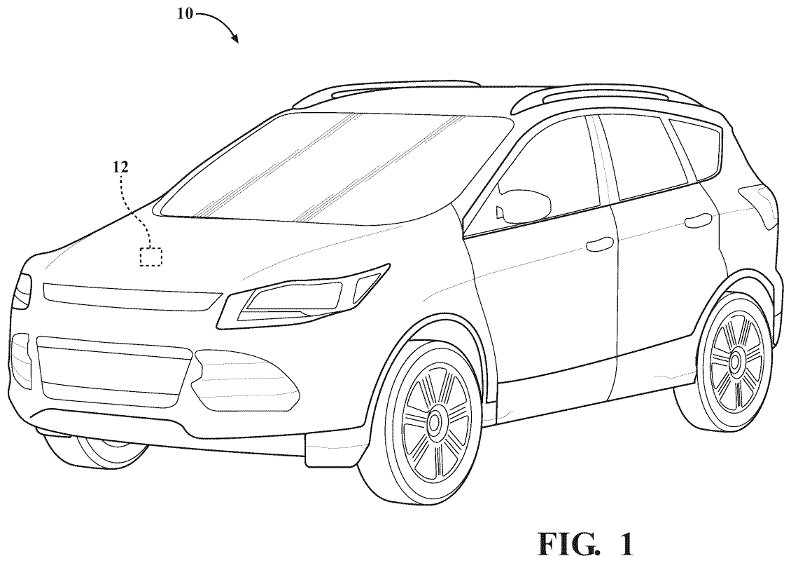

Referring to FIGS. 1-3, a fuel cell 12 is disclosed. The fuel cell 12 is configured to use an electric current to split water molecules into hydrogen and oxygen gases. Additionally, the fuel cell 12 may be incorporated into devices that require energy such as an appliance or a vehicle 10, as shown in FIG. 1. When the fuel cell 12 is incorporated into the vehicle 10, the vehicle 10 maybe an electric vehicle 10 (EV) and may include autonomous or semi-autonomous capabilities. Alternatively, the vehicle 10 may be a hybrid vehicle 10 incorporating both EV and internal combustion engine (ICE) components and capabilities. The vehicle 10 also includes the fuel cell 12 configured to provide power to the vehicle 10. More specifically, vehicles 10 including fuel cells 12 are powered by compressed hydrogen gas that feeds into an onboard fuel cell 12 stack that doesn't burn the gas, but instead transforms the fuel's chemical energy into electrical energy to power an electric motor to power the vehicle 10.

Generally, fuel cells 12 include a cathode portion disposed on one end and an anode portion disposed on an opposite end from the cathode portion. The cathode portion includes a negatively charged electrode by which electrons enter the fuel cell 12. Additionally, the anode portion includes a positively charged electrode by which protons enter and electrons leave the fuel cell 12. Further, the anode portion includes an electrode through which current flows in from an outside circuit. To provide fluid such as water, fuel, or the like to the cathode portion and the anode portion, the fuel cell also includes a plurality of ducts 20 through which fluid can be supplied. More specifically, one or more ducts 20 may supply fluid to the anode portion, called anode ducts 20, and one or more ducts 20 may supply fluid to the cathode portion, called cathode ducts 20. Additionally, the duct 20 may be integrated with a subsystem, may stand alone, or may be a HENN Connector™ of the fuel cell 12. Regardless of where the duct 20 is located, the duct 20 must be able to withstand the environmental conditions within the fuel cell, (i.e., high hydrogen gas (H₂) concentrations, saturated water, and high temperature/humidity). Additionally, the duct 20 must have a high flame retardancy level to prevent the spread of fire while maintaining the flexibility required to provide fluid to the desired locations.

To achieve the required level of flame retardancy while maintaining flexibility, the duct 20 includes a duct body 22 including a flexible network 30 and a surface coating 36 disposed on an outer surface 26 of the duct body 22. More specifically, the duct body 22 defines an aperture 24 configured to allow fluid to flow therethrough. Further, the duct body 22 may be comprised of one or more of plastic, composite plastic, or metallic plastic. For example, the plastic may include block-copolymers, such as polyamide, polyphthalamide, polybutylene terephthalate, polyketone, polyether ether ketone, polyetherketoneketone, polyimide, polyamide imide, or poly (ether-ester) elastomer.

Additionally, the duct body 22 may be reinforced. For example, if the duct body 22 is comprised of a plastic or composite plastic, the duct body 22 may be reinforced using one or more of glass fiber, carbon fiber, or graphene. Moreover, if the duct body 22 is comprised of a metallic plastic, the duct body 22 may be reinforced using one or more of metallic powders reinforcement or metallic scaffolds reinforcement.

Moreover, the duct 20 is configured to be pressurized, using one or more of H₂ (e.g., for an anode duct 20) or H₂ and/or water (e.g., for a cathode duct 20). The material of the duct body 22 may be H₂ permeable such that when H₂ or water flows through the aperture 24 and is in contact with the duct body 22, the polymer chain of the material of the duct body 22 may break into smaller polymer chain portions causing plasticizing or hardening. This hardening provides the rigidity needed for the duct body 22 within the fuel cell while allowing additional flexibility of the duct body 22 during assembly and packaging of the fuel cell. Moreover, this process helps prevent degradation of structural integrity as the process continues throughout use providing consistent structural integrity to the duct body 22.

Additionally, the H₂ permeability of the duct body 22 may be adjusted using the flexible network 30. As such, the flexible network 30 is configured to provide adjustable flexibility to the duct body 22. More specifically, the flexible network 30 is comprised of one or more of a polymeric material or an inorganic material. More specifically, the material may be one or more of polyethylene terephthalate fibers or silica fibers. In another example, the flexible network 30 may be comprised of a stackable material such as fabric. In yet another example, the flexible network 30 includes an adhesive, which contains soft segments and hard segments. More specifically, the adhesive may be a polyurethane adhesive that includes soft amorphous segments comprised of ether bonded to hard crystalline segments comprised of ester. Additionally, the crystalline segments may have crystallinity ranges between 10%-80%. Further, the soft segments are stretchable and may have elongation at break ranges between 3%-300%.

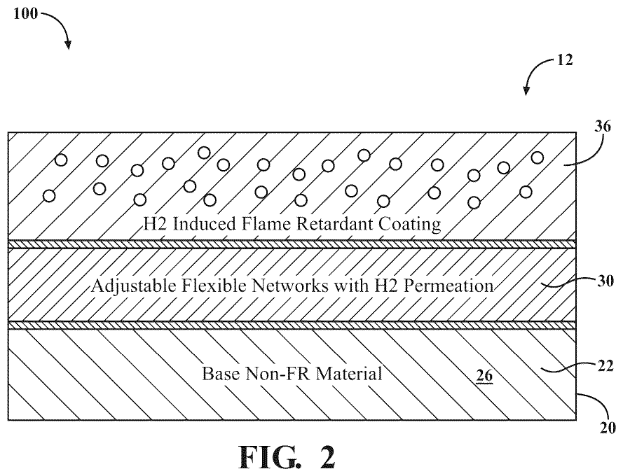

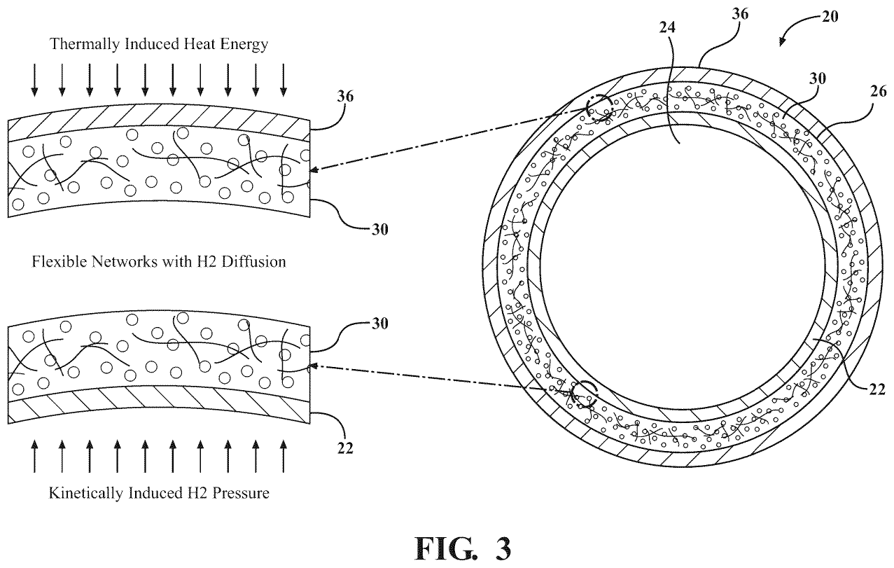

Referring still to FIGS. 2 and 3, the duct 20 also includes the surface coating 36 disposed on the outer surface 26 of the duct body 22 and, more specifically, over the flexible network 30. The surface coating 36 is continuous over the outer surface 26 of the duct body 22. In some examples, the duct body 22 such as the flexible network 30 may undergo surface preparedness prior to the surface coating 36 being placed thereon. For example, the duct body 22 may undergo a surface roughness process prior to the surface coating 36 being placed thereon to assist with adhesion of the surface coating 36 onto the duct body 22.

Additionally, the surface coating 36 may be comprised of one or more of cross-linked polymers or flame retardant materials. The cross-linked polymers may include epoxy, acrylic base, and polyurethane. Moreover, the flame retardant materials may include aryl phosphate, aluminum phosphate, aluminum-zinc phosphate, nitrogen-phosphorous derivatives, aluminum oxide, zinc oxide, iron oxide, or graphene oxide. As such, the surface coating 36 provides the duct body 22 with one or more of flame retardance or additional strength, thereby preventing loss of structural integrity of the duct body 22. Further, the level of flame retardance of the surface coating 36 may be the highest level of flame retardance including a self-extinguishing level due to the increased thermal diffusion through the flexible network 30.

The duct body 22 and the surface coating 36 may be produced using spraying, curing, molding, or three-dimensional printing. For example, the duct body 22 including the flexible network 30 may be formed through molding, curing, or three-dimensional printing. The surface coating 36 may then be sprayed or molded on the outer surface 26. Additionally, the process for producing the duct body 22 and the surface coating 36 is scalable and continuous.

The duct body 22 may include other coatings or layers thereon such that the surface coating 36 in a duct body 22 can be a secondary or third layer for the optimization of both flame-retardant performance and flexibility for packaging.

The duct 20 as described herein includes the flexible network 30 which provides the duct body 22 with increased strength when placed near H₂ as the flexible network 30 is configured to be H₂ permeable. More specifically, the flexible network 30 provides good formability in which H₂ permeation can be adjustable to keep a balance between flexibility and rigidity. Further, the flexible network 30 provides a high thermal diffusivity which, along with the surface coating 36, provides increased flame retardant performance. Additionally, the duct 20 after H₂ exposures has higher modulus and materials strength. For example, tensile modulus may increase at least by 10% while elongation remains unaffected. Additionally, both formability and flexibility of the duct 20 with the surface coating 36 can be measured by using a deflection to connect duct 20 to duct 20 or duct 20 to a hose. More specifically, a range of deflection may be approximately less than 5 mm off a center of duct 20 in either longitudinal or axial alignment.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A duct for a fuel cell, the duct comprising:
a duct body defining an aperture configured to allow fluid to flow therethrough, the duct body including a flexible network configured to provide adjustable flexibility to the duct body; and
a surface coating disposed on an outer surface of the duct body, the surface coating providing the duct body with one or more of flame retardance or and structural integrity.

2. The duct of claim 1, wherein the duct body is comprised of one or more of polyamide, polyphthalamide, polybutylene terephthalate, polyketone, polyether ether ketone, polyetherketoneketone, polyimide, polyamide imide, or poly (ether-ester) elastomer.

3. The duct of claim 1, wherein the duct body is reinforced using one or more of glass fiber, carbon fiber, or graphene.

4. The duct of claim 1, wherein the flexible network is comprised of fabric.

5. The duct of claim 1, wherein the flexible network includes an adhesive containing soft segments and hard segments.

6. The duct of claim 1, wherein the duct body and surface coating are produced using spraying, curing, molding, or three dimensional printing.

7. The duct of claim 1, wherein the surface coating is a continuous coating over the outer surface of the duct body.

8. The duct of claim 1, wherein the duct body plasticizes or hardens when exposed to hydrogen gas (H₂).

9. The duct of claim 1, wherein the surface coating is comprised of cross-linked polymers.

10. A fuel cell incorporating the duct of claim 1.

11. A vehicle incorporating the fuel cell of claim 10.

12. A fuel cell system comprising:
an anode;
a cathode;
an anode duct configured to provide fluid transmission to the anode; and
a cathode duct configured to provide fluid transmission to the cathode, at least one of the anode duct or the cathode duct being a flexible duct comprising:
a duct body comprised of a flexible network configured to provide adjustable flexibility to the duct body; and
a surface coating disposed on an outer surface of the duct body, the surface coating comprised of cross-linked polymers or flame retardant materials.

13. The fuel cell of claim 12, wherein the cross-linked polymers include epoxy, acrylic base, and polyurethane.

14. The fuel cell of claim 12, wherein the flame retardant materials include aryl phosphate, aluminum phosphate, aluminum-zinc phosphate, nitrogen-phosphorous derivatives, aluminum oxide, zinc oxide, iron oxide, or graphene oxide.

15. The fuel cell of claim 12, wherein the surface coating is a continuous coating over the outer surface of the duct body.

16. The fuel cell of claim 12, wherein the duct body plasticizes or hardens when exposed to hydrogen gas (H₂).

17. A vehicle incorporating the fuel cell of claim 12.

18. A duct for a fuel cell, the duct comprising:
a duct body defining an aperture extending along a length of the duct body and configured to allow fluid including at least one of water and hydrogen gas (H₂) to flow therethrough, the duct body including a flexible network comprised of one or more of a polymeric material or an inorganic material; and
a surface coating disposed on an outer surface of the duct body and comprising one or more of epoxy, acrylic base, polyurethane, aryl phosphate, aluminum phosphate, aluminum-zinc phosphate, nitrogen-phosphorous derivatives, aluminum oxide, zinc oxide, iron oxide, or graphene oxide, the surface coating being configured to provide one or more of increased structural properties to the duct body or enhanced flame retardance properties to the duct body.

19. A fuel cell incorporating the duct of claim 18.

20. A vehicle incorporating the fuel cell of claim 19.
